(19) United States
(12) Patent Application Publication
(10) Pub. No.: US 2013/0215322 A1
(43) Pub. Date: Aug. 22, 2013

(54) DOCUMENT CAMERA WITH AUTOMATICALLY SWITCHED OPERATING PARAMETERS

(71) Applicant: Robert Haler, Kansas City, MO (US)

(72) Inventor: Robert Haler, Kansas City, MO (US)

(73) Assignee: Ken-A-Vision Manufacturing Company, Inc., Kansas City, MO (US)

(21) Appl. No.: 13/400,370

(22) Filed: Feb. 20, 2012

(51) Int. Cl. H04N 5/225

(52) U.S. Cl. 348/373; 348/E05.024

(57) ABSTRACT

A document camera comprises a base; a camera head; a camera positioned in the camera head for capturing images of documents and other objects; a flexible neck connecting the camera head to the base and permitting the camera head to be moved relative to the base; a sensor for sensing a position or orientation of the camera head relative to the base; and a control device responsive to the sensor for selecting an operating parameter of the document camera based on the position or orientation of the camera head.

### BACKGROUND

Document cameras capture images of documents and other objects so the images can be projected in class rooms, conference rooms, etc. and/or can be transmitted and viewed at remote locations for video-conferencing and related applications. Most document cameras have a base, a camera head, and a flexible or adjustable neck connecting the camera head to the base. The neck pen⁻nits the camera head to be moved to various different positions relative to the base to capture images of objects in various locations. For example, the camera head may be aimed downward toward the base to capture images of documents placed on or near the base or swiveled or otherwise moved to aim toward objects and/or persons away from the base.

All cameras initially capture images that are upside down and reverse of the imaged object's actual orientation and therefore must rotate and reverse the images for proper viewing. The orientation of the images is also affected by the direction of the camera and the orientation of the document or other object being imaged. Document cameras are typically configured to capture images of documents on or near their bases and to orient these images for reading from top to bottom. When the camera heads are shifted to capture images away from their bases, the images are often oriented upside down, sideways, or reversed. Similarly, document cameras are typically focused and configured with a field of view for documents of a particular size and a particular distance away. When the camera heads are repositioned to image people or other objects, the cameras must be re-focused and/or adjusted to a different zoom level. Document cameras have controls that can be operated to rotate images, change focus, and zoom in or out, but such controls require user manipulation and are sometimes cumbersome to use.

### SUMMARY

The present invention solves the above-described problems and provides a distinct advance in the art of document cameras. More particularly, embodiments of the present invention provide a document camera that automatically switches between viewing modes or other operating parameters to more easily accommodate imaging of a variety of different objects.

An embodiment of the document camera comprises a base for supporting the document camera on a table or other support; a head with a camera positioned therein for capturing images of documents and other objects; and a flexible or adjustable neck connecting the head to the base and permitting the head to be moved relative to the base. The document camera also comprises a sensor for sensing a position or orientation of the head relative to the base; and a control device responsive to the sensor for selecting an operating parameter of the document camera based on the position or orientation of the head.

For example, the operating parameter may be an orientation of an image captured by the camera, and the control device may select a first image orientation when the camera is aimed toward the base and a second image orientation when the camera is pointed away from the base. The operating parameter may alternatively be a magnification level or zoom of the camera, and the control device may select a first magnification level or zoom level when the camera is aimed toward the base and a second magnification level when the camera is pointed away from the base.

The operating parameter may alternatively be a frame rate of the camera, and the control device may select a first frame rate when the camera is aimed toward the base and a second frame rate when the camera is pointed away from the base. The operating parameter may also be image size or resolution. For example, when the camera is pointed down at a document, the image size may be 2048×1536, but when it is pointed at a person, the image size may be 1024×768 at 30 frames per second for a more natural web cam experience.

The operating parameter may also be a focus adjustment, and the control device may refocus the camera when it is repositioned. The control device may also switch the camera between focus modes such as a manual focus mode, a one-time auto focus mode, and a continuous auto focus mode.

The operating parameter may also be exposure control, and the control device may select a different exposure setting based on the position and/or movement of the camera.

The document camera may further comprise a light source for illuminating an object imaged by the camera. In this embodiment, the operating parameter may be a brightness level of the light source, and the control device may select a first brightness level when the camera is aimed toward the base and a second brightness level when the camera is pointed away from the base.

The document camera may further comprise a microphone for detecting voices and other sounds in the vicinity of the document camera. In this embodiment, the operating parameter may be a status of the microphone, and the control device may enable the microphone when the camera is pointed away from the base and disable the microphone when the camera is aimed toward the base. Alternatively, the control device may adjust the volume or sensitivity of the microphone based on the position of the camera.

The sensor and control device may also change an operating parameter whenever a user simply taps or touches the camera. For example, the sensor may sense a single-tap on the camera and trigger the control device to re-focus the camera, sense a double tap and trigger the control device to turn on a light, and sense a triple tap to change the exposure setting or frame rate. The sensor and control device may also change an operating parameter based on where a tap occurs. For example, a user may tap the side of the camera to trigger a re-focus, tap the top of the camera to turn lights on or off, and tap the front of the camera to change an orientation or exposure setting.

This summary is provided to introduce a selection of concepts in a simplified form that are further described in the detailed description below. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a perspective view of a document camera constructed in accordance with embodiments of the present invention.

FIG. 2 is a side view of the document camera with the camera head pointed downward toward its base.

FIG. 3 is a side view of the document camera with the camera head pointed outward toward a person or object away from the base.

FIG. 4 is a block diagram of selected components of the document camera.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of embodiments of the invention references the accompanying drawings. The embodiments are intended to describe aspects of the invention in sufficient detail to enable those skilled in the art to practice the invention. Other embodiments can be utilized and changes can be made without departing from the scope of the claims. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

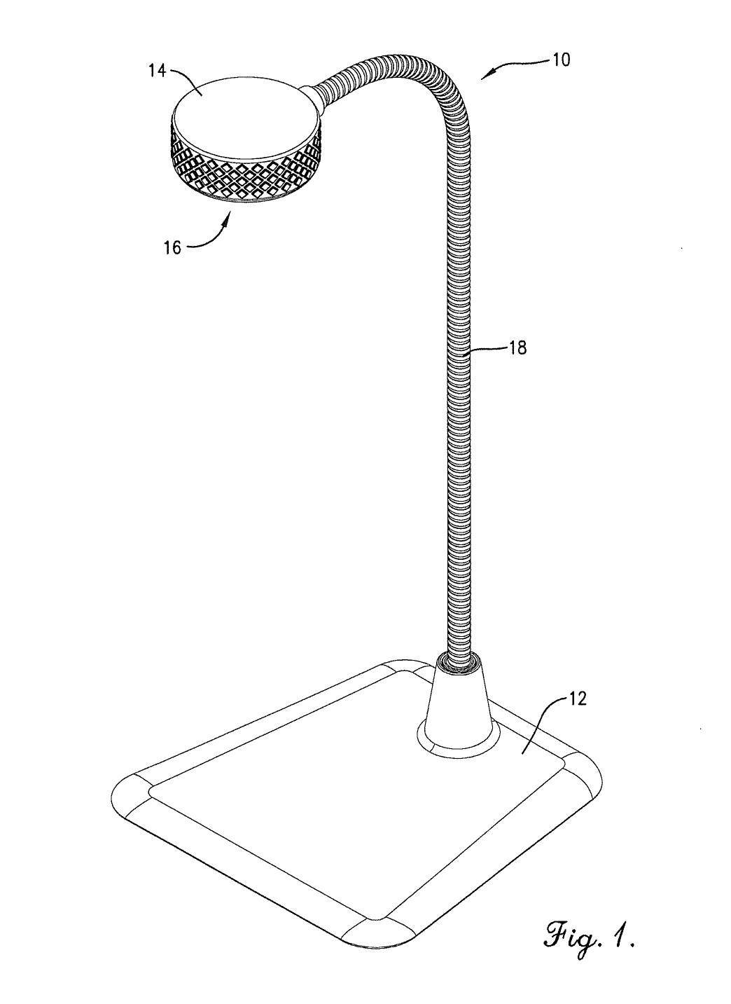

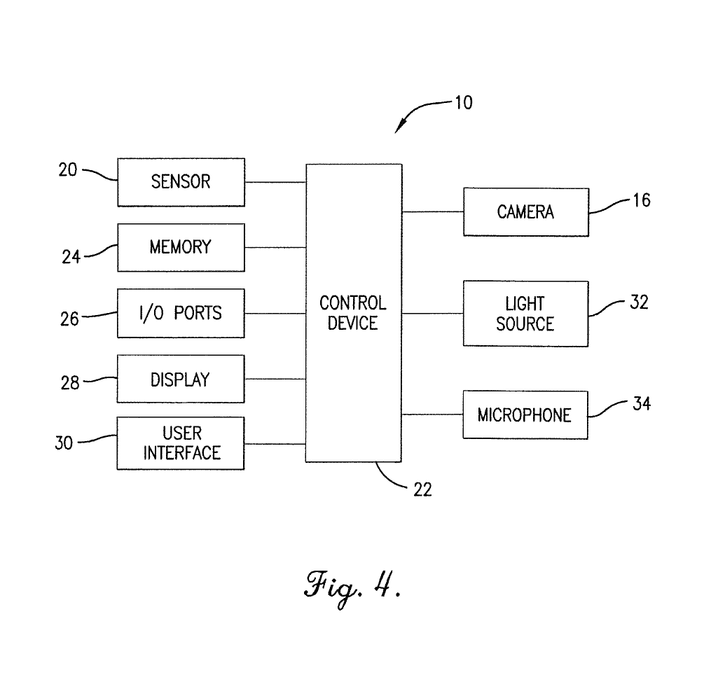

Turning now to the drawing figures, and initially FIG. 1, a document camera 10 constructed in accordance with embodiments of the invention is illustrated. The document camera 10 broadly comprises a base 12 for supporting the document camera on a table or other support; a camera head 14 with a camera 16 positioned therein for capturing images of documents and other objects; and a flexible or otherwise adjustable neck 18 connecting the camera head 14 to the base 12. As illustrated in FIG. 4, the document camera 10 also comprises a sensor 20 for sensing a position or orientation of the camera head relative to the base and a control device 22 responsive to the sensor 20 for selecting an operating parameter of the document camera based on the position or orientation of the head. Embodiments of the document camera 10 may include other components as described below.

In more detail, the base 12 may be of any size and shape and may be made of any suitable material such as metal, plastic, or glass. The base 12 may enclose some of the electronic components of the document camera as is conventional.

Similarly, the camera head 14 may be of any size and shape that is suitable for enclosing the camera 16 and may be made of the same material as the base or a different material. The camera head 14 may also enclose some of the electronic components of the document camera.

The camera 16 is positioned in the camera head 14 and is operable for imaging documents, persons, and other objects. The camera 16 may consist of any type of image sensor such as a CCD, CMOS, or progressive scan CCD sensor or sensors. In one embodiment, the camera consists of a 3.2 megapixel CMOS device with a pixel count of 2048×1536.

The neck 18 connects the camera head 14 to the base 12 and permits the camera head 14 to be moved relative to the base. The neck 18 may be a gooseneck type support or any other flexible or adjustable support. In one embodiment, the neck is a 20″ memory free surgical flexible gooseneck.

The sensor 20 may be a level sensor, accelerometer, position switch, or any other device or components capable of sensing a position or orientation of the camera head 14 relative to the base 12. The sensor may even be software that analyzes images from the camera and determines that the camera has been moved based on changes to the images. One embodiment of the sensor 20 comprises one or more accelerometers positioned in the camera head 14. Other embodiments of the sensor 20 may comprise levels or position switches positioned in the neck 18.

The control device 22 monitors the sensor 20 and controls operating parameters of the document camera 10 as described herein. The control device 22 may include any number of processors, controllers, integrated circuits, programmable logic devices, or other control devices and resident or external memory for storing data and other information accessed and/or generated by the document camera. The control device 22 may be coupled with the other electronic components of the document camera through wired or wireless connections such as a data bus to enable information to be exchanged between the various components.

The control device 22 may implement one or more computer programs and/or code segments to perform some of the functions described herein. The computer programs may comprise ordered listings of executable instructions for implementing logical functions in the control device 22 as described in more detail below.

The document camera 10 may also include memory 24. The memory may be integral with the control device 22, stand-alone memory, or a combination of both. The memory 24 may include, for example, removable and non-removable memory elements such as RAM, ROM, flash, magnetic, optical, USB memory devices, and/or other conventional memory elements.

The memory 24 may store various data associated with the operation of the document camera, such as computer programs and code segments, or other data for instructing the control device 22 and other system elements to perform the steps described herein. The memory 24 may store, for example, a look-up table or other memory structure that stores data representative of various operating parameters of the document camera and positions or orientations of the camera head that correspond to each operating state. Examples of the operating parameters are described below.

The document camera 10 may also comprise one or more inputs or I/O ports 26 that permit data and other information to be transferred to and from the control device 22. The I/O ports may be any wireless or wired device or devices capable of receiving or transmitting signals or data to or from external sources. The I/O ports may comprise, for example, one or more Ethernet ports, USB Ports, memory card slots, video ports, radio frequency (RF) receivers, infrared (IR) receivers, Wi-Fi receivers, Bluetooth devices, electrical terminals, or even electrical wires.

Embodiments of the document camera 10 may also comprise a display 28 to display various information corresponding to operation of document camera 10. The display 28 may comprise conventional black and white, monochrome, or color display elements including CRT, TFT, LCD, and/or plasma display devices. The display 28 may be a touch-screen display to enable users to interact with it by touching or pointing at display areas to provide information to the control device.

Embodiments of the document camera 10 may also comprise a user interface 30 that permits a user to interact with the control device 22. The user interface 30 may comprise one or more functionable inputs such as buttons, switches, scroll wheels, the touch screen described above, voice recognition elements such as a microphone, pointing devices such as mice, touchpads, tracking balls, styluses, combinations thereof, etc. Further, the user interface 30 may comprise wired or wireless data transfer elements such as a removable memory including the memory 24, data transceivers, etc. The user interface 30 may also include a speaker for providing audible instructions and feedback. The user interface may even include software that analyzes images taken by the camera and identifies selected objects or gestures by the user via image analysis to serve as a control mechanism.

Embodiments of the document camera 10 may also comprise a light source 32 for illuminating documents and other objects imaged by the document camera. In one embodiment, the light source may comprise one or more high output LEDS.

Embodiments of the document camera 10 may also comprise a microphone 34 for detecting voices or other sounds in the vicinity of the document camera. The microphone 34 may be of any type and rating.

Some of the components described herein may be housed together in the base 12 and/or the camera head 14. However, the components need not be physically connected to one another since wireless communication among the various components is possible and intended to fall within the scope of the present invention.

Aspects of the invention may be implemented with one or more computer programs stored in or on non-transitory computer-readable medium residing on or accessible by the control device 22 such as the memory 24. Each computer program preferably comprises an ordered listing of executable instructions for implementing logical functions in the control device. Each computer program can be embodied in any non-transitory computer-readable medium for use by or in connection with an instruction execution system, apparatus, or device, such as a computer-based system, processor-containing system, or other system that can fetch the instructions from the instruction execution system, apparatus, or device, and execute the instructions. In the context of this application, a “computer-readable medium” can be any non-transitory means that can store the program for use by or in connection with the instruction execution system, apparatus, or device. The computer-readable medium can be, for example, but not limited to, an electronic, magnetic, optical, electro-magnetic, infrared, or semi-conductor system, apparatus, or device. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

In use, embodiments of the document camera 10 automatically switch between viewing modes or other operating parameters to more easily accommodate imaging of a variety of different objects. In one embodiment, the sensor 20 senses a position or orientation of the camera head 14 relative to the base 12, and the control device 22 selects an operating parameter of the document camera based on the position or orientation of the head.

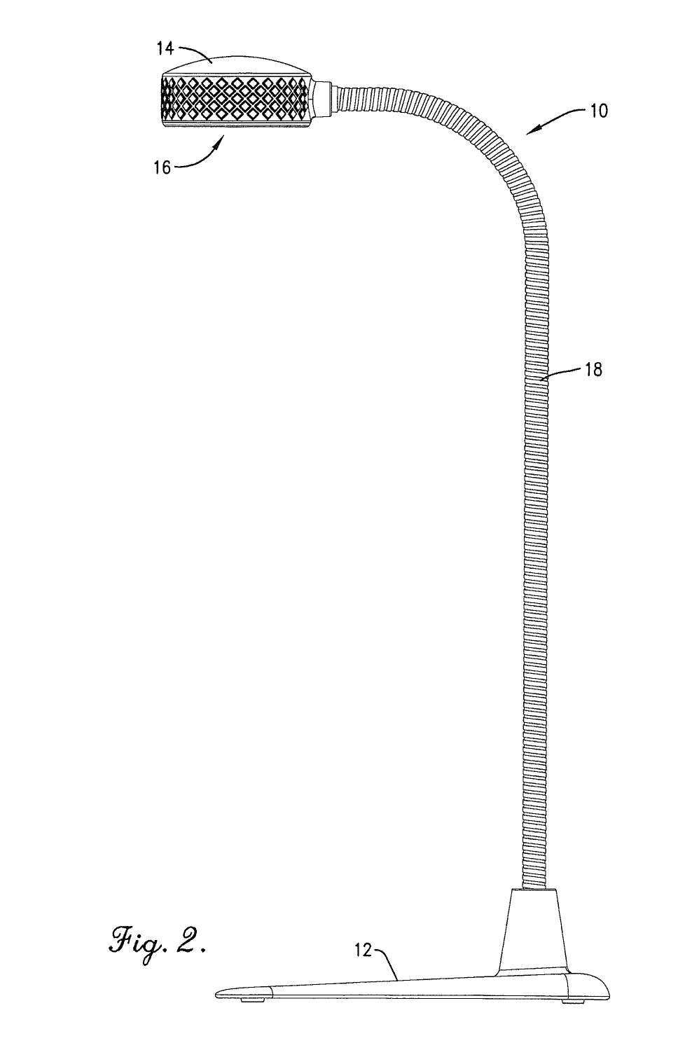

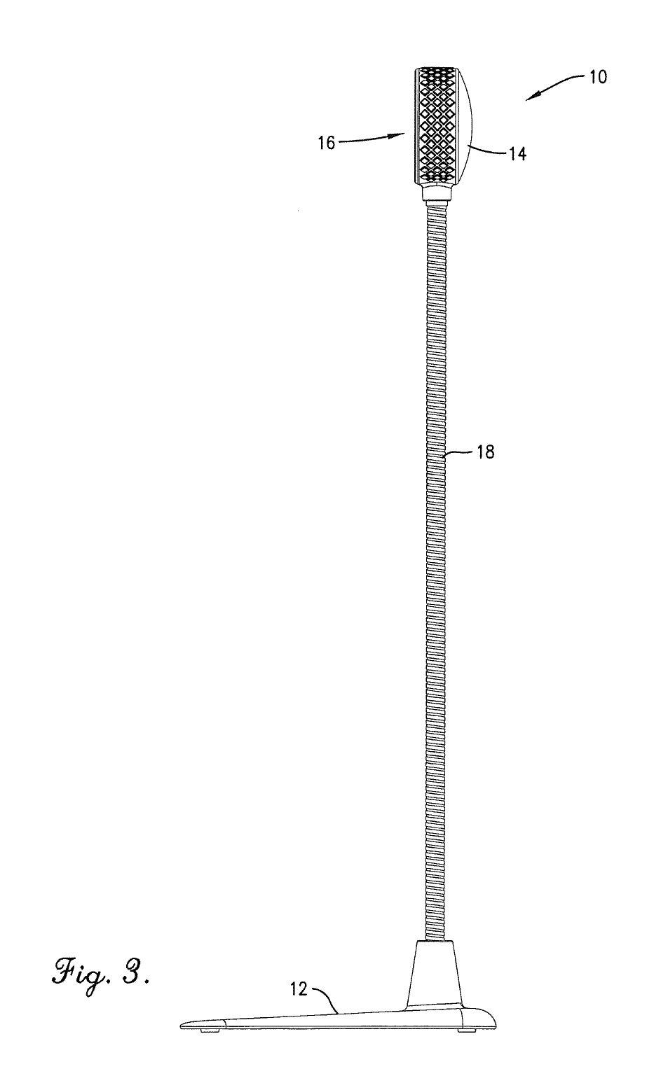

For example, the operating parameter may be an orientation of an image captured by the camera, and the control device 22 may select a first image orientation when the camera 16 is aimed toward the base 12 as shown in FIGS. 1 and 2 and a second image orientation when the camera 16 is pointed away from the base 12 as shown in FIG. 3. This allows a user to operate the document camera to image documents and to then shift the camera head to image other objects without having to rotate or otherwise manually change the image orientation of the document camera.

The operating parameter may alternatively be a magnification level or zoom level of the camera 16. The control device 22 may select a first magnification level or zoom level when the camera 16 is aimed toward the base as shown in FIGS. 1 and 2, and a second magnification level when the camera is pointed away from the base as shown in FIG. 3. For example, the first magnification level or zoom level may be a field of view of 11″×17″ to capture images of documents, and the second magnification level or zoom level may be a wider field of view to capture images of people or larger objects.

The operating parameter may also be a frame rate of the camera, and the control device 22 may select a first frame rate when the camera is aimed toward the base and a second frame rate when the camera is pointed away from the base. The operating parameter may also be image size or resolution. For example, when the camera is pointed down at a document, the image size may be 2048×1536, but when it is pointed at a person, the image size may be 1024×768 at 30 frames per second for a more natural web cam experience.

The operating parameter may also be a status of the light source 32, and the control device 22 may enable the light source when the camera 16 is aimed toward the base and disable the light source when the camera is pointed away from the base. Similarly, the operating parameter may also be a brightness level of the light source 32, and the control device 22 may select a first brightness level when the camera 16 is aimed toward the base and a second brightness level when the camera is pointed away from the base. The brightness levels could be fixed or user-selectable.

The operating parameter may also be a status of the microphone 34, and the control device 22 may enable the microphone when the camera is pointed away from the base and disable the microphone when the camera is aimed toward the base. The control device 22 may also adjust the sensitivity or volume of the microphone based on the position of the camera head.

The operating parameter may also be a focus adjustment, and the control device may refocus the camera when it is repositioned. The control device may also switch the camera between focus modes such as a manual focus mode, a one-time auto focus mode, and a continuous auto focus mode.

The operating parameter may also be exposure control, and the control device may select a different exposure setting based on the position and/or movement of the camera.

The sensor and control device may also change an operating parameter whenever a user simply taps or touches the camera. For example, the sensor may sense a single-tap on the camera and trigger the control device to re-focus the camera, sense a double tap and trigger the control device to turn on a light, and sense a triple tap to change the exposure setting or frame rate. The sensor and control device may also change an operating parameter based on where a tap occurs. For example, a user may tap the side of the camera to trigger a re-focus, tap the top of the camera to turn lights on or off, and tap the front of the camera to change an orientation or exposure setting.

Although the invention has been described with reference to the preferred embodiment illustrated in the attached drawing figures, it is noted that equivalents may be employed and substitutions made herein without departing from the scope of the invention as recited in the claims. For example, the control device 22 may control additional viewing modes or other operating parameters of the document camera 10 not described herein.

Having thus described the preferred embodiment of the invention, what is claimed as new and desired to be protected by Letters Patent includes the following:

1. A camera comprising:
a base for supporting the camera on a table or other support;
a camera head;
a camera positioned in the camera head for capturing images of documents and other objects;
a neck connecting the camera head to the base and permitting the camera head to be moved relative to the base;
a sensor for sensing a position or orientation of the camera head relative to the base;
and
a control device responsive to the sensor for selecting an operating parameter of the document camera based on the position or orientation of the camera head.

2. The camera as set forth in claim 1, wherein the sensor is a level sensor, accelerometer, or position switch located in the camera head or the neck.

3. The camera as set forth in claim 1, wherein the operating parameter is an orientation of an image captured by the camera and wherein the control device selects a first image orientation when the camera head and camera are aimed toward the base and a second image orientation when the camera head and camera are pointed away from the base.

4. The camera as set forth in claim 1, wherein the operating parameter is a magnification level of the camera and wherein the control device selects a first magnification level when the camera head and camera are aimed toward the base and a second magnification level when the camera head and camera are pointed away from the base.

5. The camera as set forth in claim 1, further comprising a light source, wherein the operating parameter is a brightness level of the light source and wherein the control device selects a first brightness level when the camera head and camera are aimed toward the base and a second brightness level when the camera head and camera are pointed away from the base.

6. The camera as set forth in claim 1, wherein the operating parameter is a frame rate of the camera and wherein the control device selects a first frame rate when the camera head and camera are aimed toward the base and a second frame rate when the camera head and camera are pointed away from the base.

7. The camera as set forth in claim 1, further comprising a microphone, wherein the operating parameter is a status of the microphone and wherein the control device enables the microphone when the camera head and camera are pointed away from the base and disable the microphone when the camera head and camera are aimed toward the base.

8. The camera as set forth in claim 1, wherein the operating parameter is a focus of the camera, an exposure level of the camera, or an image size or resolution of the camera.

9. A camera comprising:
a base for supporting the camera on a table or other support;
a camera head;
a camera positioned in the camera head for capturing images of documents and other objects;
a flexible neck connecting the camera head to the base and permitting the camera head to be moved relative to the base;
a sensor positioned in the camera head for sensing a position or orientation of the camera head relative to the base; and
a control device responsive to the sensor for selecting an operating parameter of the camera based on the position or orientation of the camera head, wherein the operating parameter is an orientation of an image captured by the camera or a magnification level of the camera.

10. The camera as set forth in claim 9, wherein the sensor is a level sensor, accelerometer, or position switch.

11. The camera as set forth in claim 9, wherein the control device selects a first image orientation when the camera head and camera are aimed toward the base and a second image orientation when the camera head and camera are pointed away from the base.

12. The camera as set forth in claim 9, wherein the control device selects a first magnification level when the camera head and camera are aimed toward the base and a second magnification level when the camera head and camera are pointed away from the base.

13. The camera as set forth in claim 9, further comprising a light source, wherein the operating parameter also comprises a brightness level of the light source and wherein the control device selects a first brightness level when the camera head and camera are aimed toward the base and a second brightness level when the camera head and camera are pointed away from the base.

14. The camera as set forth in claim 9, wherein the operating parameter also comprises a frame rate of the camera and wherein the control device selects a first frame rate when the camera head and camera are aimed toward the base and a second frame rate when the camera head and camera are pointed away from the base.

15. The camera as set forth in claim 9, further comprising a microphone, wherein the operating parameter is a status of the microphone and wherein the control device enables the microphone when the camera head and camera are pointed away from the base and disable the microphone when the camera head and camera are aimed toward the base.

16. The camera as set forth in claim 9, wherein the operating parameter is a focus of the camera, an exposure level of the camera, or an image size or resolution of the camera.

17. A camera comprising:
a base for supporting the camera on a table or other support;
a camera head;
a camera positioned in the camera head for capturing images of documents and other objects;
a flexible neck connecting the camera head to the base and permitting the camera head to be moved relative to the base;
a light source for illuminating documents and other objects imaged by the camera;
a microphone for detecting sounds near the document camera;
a sensor positioned in the camera head for sensing a position or orientation of the camera head relative to the base; and
a control device responsive to the sensor for selecting operating parameters of the camera based on the position or orientation of the camera head, wherein the operating parameters include an orientation of an image captured by the camera a magnification level of the camera, a brightness level of the light source, and a status of the microphone.

18. The camera as set forth in claim 17, wherein the sensor is a level sensor, accelerometer, or position switch.

19. The camera as set forth in claim 17, wherein the control device selects a first image orientation when the camera head and camera are aimed toward the base and a second image orientation when the camera head and camera are pointed away from the base.

20. The camera as set forth in claim 17, wherein the control device selects a first magnification level when the camera head and camera are aimed toward the base and a second magnification level when the camera head and camera are pointed away from the base.
